(19) United States
(12) Patent Application Publication
(10) Pub. No.: US 2024/0156105 A1
(43) Pub. Date: May 16, 2024

(54) USE OF A RED ALGA EXTRACT AS NEMATOSTATIC AND/OR NEMATICIDAL AGENT

(71) Applicant: AGRO INNOVATION INTERNATIONAL, SAINT-MALO (FR)

(72) Inventor: Emmanuel Eric NGUEMA-ONA, SAINT-MALO (FR)

(21) Appl. No.: 18/550,728

(22) PCT Filed: Mar. 17, 2022
(86) PCT No.: PCT/FR2022/050483

§ 371 Date: Sep. 15, 2023

(30) Foreign Application Priority Data
Mar. 18, 2021 (FR) FR2102737

(51) Int. Cl. A01N 65/03; A01P 5/00

(52) U.S. Cl. CPC A01N 65/03; A01P 5/00

(57) ABSTRACT

The invention concerns (i) the use of a red alga extract as nematostatic agent against nematodes and/or as a nematicidal agent against nematodes and (ii) a method for treating soil to promote growth of a plant by reducing nematodes access to the roots of said plant or by eliminating nematodes present in said soil, said method comprising supplying said soil with a red alga extract.

### TECHNICAL FIELD

The invention concerns the use of a red alga extract as nematostatic agent against nematodes and/or as a nematicidal agent against nematodes.

### PRIOR ART

Nematodes are vermiform animals, in the vast majority of cases microscopic in size. They are found in almost every environment, both as parasites and as free-living organisms. They are dependent on the presence of water for their survival, in particular interstitial water for the nematodes present in the soil. The life cycle of nematodes necessarily goes through a larval phase (this is what is meant by juveniles) and a mobile phase, giving nematodes the ability to move in the soil over short distances.

Plant parasitic nematodes are capable of causing significant damage to cultivated plants and are extremely widespread. There are more than 4000 species of plant-parasitic nematodes identified.

Indeed, they parasitize a large number of crops of economic interest and are present in all types of soil, which impacts agricultural production. Plant-parasitic nematodes may need well-identified host crops to feed on and complete their life cycle, and are then called obligate parasites. Plant-parasitic nematodes can also do without the presence of host crops to complete their biological cycle and are then called facultative parasites. In both cases, they cause significant damage to crop production. Moreover, it is recognized that plant-parasitic nematodes reduce world agricultural production by approximately 11%, that is to say a harvest loss of several million tons each year, corresponding to an estimated economic cost worldwide of 100 billions of dollars a year.

Nematodes have a worldwide distribution and are present in the surface layers of the soil. They are suitable for any type of environment: salt water, fresh water, from the polar regions to the tropics. They are the most numerous and widespread animal group in the soil. Their larvae can remain alive for decades in the form of cysts.

The means of combating these phytopathogens are multiple but sometimes difficult to implement or partially effective. In addition to chemical nematicides (such as chemical fumigation), physical treatment techniques (solarization) and respect for agricultural practices, or even the use of certain biofumigants, new control methods can be: supplying the soil with natural predator biological organisms of nematodes, the genetic improvement of plants to make them resistant to these pathogens or the natural stimulation of plant defenses by elicitors, or else the use of bio-nematicides or natural extracts with nematostatic properties.

Fumigation products are the conventional means for controlling nematodes, particularly in the USA, France, Japan, Italy and Spain, and represent 45% of nematicide sales. However, they are expensive and therefore limited to high value crops.

Chemical nematicides represented in 2011, 55% of total sales and are the most used in Brazil, UK, Mexico, South Africa, China and Argentina. These products are often toxic and have the disadvantage of being broad-spectrum biocides, which often have an impact on the entire present ecosystem, eliminating all forms of life in the crops.

In Europe, the crops most affected by nematode infestation are field crops (beets, maize, durum wheat and rapeseed), vegetable crops (carrots, potatoes, solanaceae, cucurbits, lettuce) and perennial crops such as the vine.

For environmental and health reasons, almost all the most effective nematicides are/will be withdrawn from the market, leaving the sectors with few solutions.

In this context, there is a need to develop alternative methods to protect crops against plant-parasitic nematodes.

### SUMMARY OF THE INVENTION

Thus, the present invention, which finds application in the agro-ecological and agricultural field, aims at proposing a new use of a red alga extract as nematostatic agent against nematodes and/or as a nematicidal agent against nematodes.

According to a first aspect, the invention concerns a use of a red alga extract as nematostatic agent against nematodes and/or as a nematicidal agent against nematodes.

According to a second aspect, the invention concerns a method for treating soil to promote growth of a plant by reducing nematodes access to the roots of said plant and/or by eliminating nematodes present in said soil, said method comprising supplying said soil with a red alga extract.

### DETAILED DESCRIPTION

### Definitions

The term “nematode” encompasses both nematode larvae and adult nematodes. The nematode larvae correspond to the larval development stages L1, L2, L3, and/or L4. The stages of development L2 and L3 are known to be the mobile and infective phases of nematode larvae. Adult nematodes correspond to the immature stage and the mature stage. The different stages of nematode development are described in FIG. 1, stage L5 corresponding to the first stage of the adult nematode. In the context of the present invention, the nematodes are advantageously nematode larvae, preferably nematode larvae at stage L2 and/or L3. The nematodes (for example from genus Paratylenchus), Pratylenchidae (for example are preferably pathogenic nematodes, in particular plant-pathogenic nematodes (also called phytoparasites) for example selected from the families Anguinidae (for example from genus Ditylenchus), Longidoridae (for example selected from the genera Xiphinema, Longidorus), Tylenchulidae (for example from genus Paratylenchus), Pratylenchidae (for example selected from genera Pratylenchus, Radopholus, Pratylenchoides, Noccobus), Hoplolaimidae (for example from genus Rotylenchus), Tylenchulidae (for example from genus Tylenchulus), Trichodoridae (for example from genus Paratrichodorus), Heterodoridae (for example selected from the genera Globodera, Heterodera), and Meloidogynidae (for example from genus Meloidogyne).

The term “nematostatic agent” or “nematostatic composition” means an agent or composition which immobilizes the nematode temporarily. The immobilization of the nematode can last at least one day, for example at least two days, at least three days, at least four days, at least five days, at least six days, at least seven days. This immobilization has the effect of preventing the nematodes from moving towards a host plant and infecting it during the period of immobilization.

The term “nematicidal agent” or “nematicidal composition” refers to an agent or composition that irreversibly immobilizes a nematode. This irreversible immobilization can lead to the death of the nematode.

The term “red alga” designates a red alga living in an aquatic environment, and more specifically in the seas and oceans, which can be used in agriculture, food and industry in general. Red algae belong to the Rhodophytae group. In particular, the red alga can be selected from the genus Palmaria, the genus Porphyra, or the genus Chondrus, preferably the genus Porphyra and/or Palmaria spp. According to a preferred embodiment of the invention, the red alga is selected from Porphyra spp, Porphyra columbina, Porphyra acanthophora, Porphyra tenera (also called Pyropia tenera), Porphyra perforata, Porphyra vietnamensis, Porphyra rosengurttii, Porphyra yezoensis (also called Pyropia yezoensis), Porphyra haitanensis, even more preferably Porphyra spp or Porphyra columbina.

The term “red alga extract” designates the product resulting from the extraction of the contents of the cells of a red alga. The red alga extract can be obtained by a method including the following steps: mixing of fresh or dry red alga, preferably crushed, with water, extraction (solid-liquid separation) and optionally fractionation and/or or concentration. The red alga can be easily harvested using conventional methods described in the literature. The dry red alga generally contains less than 5% water, preferably less than 3% water, by mass relative to the total mass of alga. The red alga extract is advantageously obtained by extraction with an aqueous solvent or an organic solvent, for example by aqueous extraction at an acid pH. The red alga extract can be in dry form or in liquid form, preferably in liquid form. Thus, the water of the red alga extract can be eliminated in order to obtain a more or less dry or liquid red alga extract, for example containing at least 10% of dry matter by mass relative to the total mass of the red alga extract, for example at least 20% dry matter, at least 30% dry matter, at least 40% dry matter, at least 50% dry matter, at least 60% dry matter, at least 70% dry matter, at least 80% dry matter, at least 90% dry matter, at least 95% dry matter, preferably between 1 and 15% dry matter, for example 8% dry matter. The extract may optionally be ultra-filtered in order to obtain a fraction having improved nematostatic and/or nematicidal activity compared to the non-ultra-filtered red alga extract.

The term “biostimulant” designates a substance, or a mixture of substances, which is natural or of synthetic origin, used in agriculture, horticulture and forestry, to improve soils, in particular their structure, and to fertilize cultivated plants. Biostimulants comprise fertilizers and amendments.

The term “fertilizer” designates fertilizing materials the main function of which is to supply plants with elements that are directly useful for their nutrition (major fertilizing elements, secondary fertilizing elements and oligoelements).

The term “amendment” designates a substance intended to improve the quality of the soil, and in particular intended to improve the pH of the soil. Advantageously, the amendment is selected from base mineral amendments of limestone and/or limestone and magnesium type; humus-containing amendments such as compost or manure type.

The expression “plant” means in the present application the plant considered as a whole, including its root apparatus, its vegetative apparatus, seeds, grains and fruits.

The nematostatic effect can be measured using an “active passage” test which allows to measure, under in vitro conditions, the ability of a nematode to be temporarily immobilized by an agent or a composition, then to regain mobility after a determined time. An “active passage” test which can be implemented in the context of the present invention is detailed in Example 2. The nematostatic effect can also be measured indirectly by measuring the disturbance of the infectious cycle of nematodes related to the immobilization of nematodes, in particular by determining the gall index (for example after an infestation by gall nematodes of the genus Meloidogyne), or else by determining the Pf/Pi ratio (with Pf corresponding to the number of cysts present in said plot at a time t_{f}, for example at the end of the growing season and, Pi corresponding to the number of nematode cysts present in a plot at a time tᵢ, for example at the start of the growing season). A test allowing to determine the Pi/Pf ratio is detailed in Example 6.

Thus, in the context of the present invention, an effective amount to have a nematostatic effect corresponds to an amount allowing (i) to temporarily immobilize at least 10% of the nematodes, advantageously at least 20%, for example at least 30%, at least 40%, at least 50%, at least 60%, at least 70%, at least 80%, at least 90% or 100% of the nematodes in an “active passage” test, (ii) to decrease the gall number by at least 10%, advantageously by at least 20%, for example by at least 30%, by at least 50% or by at least 70%, or (iii) to obtain a Pf/Pi ratio less than or equal to 1, preferably less than 0.8, less than 0.6, less than 0.4, or even less than 0.2.

The nematicidal effect can be measured with the same measurement methods listed for the nematostatic effect. Thus, in the context of the present invention, an amount which is effective to have a nematicidal effect allows (i) to irreversibly immobilize at least 10% of the nematodes, advantageously at least 20%, for example at least 30%, at least 40%, at least 50%, at least 60%, at least 70%, at least 80%, at least 90% or 100% of the nematodes in an “active passage” test, (ii) to decrease the gall index by at least 10%, advantageously by at least 20%, for example by at least 30%, by at least 50% or by at least 70%, or (iii) to obtain a ratio Pf/Pi less than or equal to 1, preferably less than 0.8, less than 0.6, less than 0.4, or even less than 0.2.

The present invention stems from the surprising advantages demonstrated by the inventors of the effect of a red alga extract as nematostatic agent against nematodes and/or as a nematicidal agent against nematodes.

Composition

The present application concerns a nematostatic and/or nematicide composition comprising a red alga extract, said extract having been obtained by aqueous extraction at an acid pH.

The red alga extract can be obtained by aqueous extraction at an acid pH, for example at a pH comprised between 1 and 7, preferably between 2 and 6, even more preferably between 2 and 5, for example a pH ranging from 2.5 to 5.5, a pH ranging from 3 to 4.5, for example a pH equal to 2.5+/−0.1. The pH is measured using a pH-meter probe. Aqueous extraction at acid pH is possible with an aqueous solvent to which an acid solution, preferably a strong acid solution, is added. The acid solution allows the pH to be adjusted during extraction to the desired pH. For example, the acid is selected from sulfuric acid (H₂SO₄), citric acid, acetic acid, preferably sulfuric acid. The amount of acid used during the extraction will be easily adjusted according to the desired final pH.

When an acid solvent is used to obtain the red alga extract, all or part of said acid solvent is advantageously removed before using the red alga extract as nematostatic and/or nematicidal agent. For example, the acid solvent can be removed by evaporation. Thus, advantageously, the red alga extract used in the context of the present invention is devoid of acid solvent.

Irrespective of the use of an acid solvent in the preparation of the extract, the red alga extract is preferably devoid of acid other than the acids naturally present in the red alga used to prepare the red alga extract. In this case, the composition is devoid of acid other than the acids naturally present in the red alga used to prepare the red alga extract.

In particular, the composition is devoid of carboxylic acid, preferably the extract is devoid of carboxylic acid selected from formic acid, acetic acid, lactic acid, citric acid, oxalic acid, propionic acid, malic acid, tartaric acid, fumaric acid, gluconic acid, sorbic acid and butyric acid. In a particular embodiment, the composition is devoid of formic acid.

In addition, the red alga extract is advantageously obtained by aqueous extraction at a temperature ranging from 10 to 50° C., preferably ranging from 20 to 50° C., for example at a temperature ranging from 15 to 45° C., for example at 25° C., 30° C., 35° C., or 40° C.

The red alga extract can be obtained by mixing crushed red algae with an acid aqueous solvent at a temperature ranging from 20 to 50° C., preferably 40° C., and at a pH ranging from 3 to 4.5, preferably a pH of 2.5.

For example, red alga extract is obtained by mixing dried and crushed red algae with water at a temperature of 40° C. for 3 hours, then adding sulfuric acid so that the pH of the mixture is acid, for example at pH 2.5, then centrifuging the mixture to eliminate the solid fraction and recover the liquid fraction. The liquid fraction can be used as such as red alga extract or can undergo one or more subsequent treatments, such as for example filtration and/or precipitation.

The red alga extract can be obtained by implementing the method described in Example 1, in particular Example 1A and Example 1B (FIG. 2).

The composition can be in liquid or solid form.

When it is in solid form, the composition may be in powder or granule form, advantageously in granule form. The preparation of such a composition can be carried out using the general knowledge of a person skilled in the art.

The composition comprises a sufficient amount of red alga extract to have a nematostatic effect against nematodes and/or a nematicide against nematodes, when it is applied to the soil. The composition may comprise an amount of red alga extract less than 50% by weight, less than 40%, less than 30%, less than 20%, less than 10%, for example ranging from 2 to 10% by weight, preferably ranging from 5 to 7% by weight, relative to the total weight of the composition.

The composition may further comprise at least one biostimulant, preferably selected from an amendment or a fertilizer. Such compositions allow to best meet the growth needs of the plant, which will be expressed in particular in terms of improving the development of the plant and the yield.

As examples of biostimulant which can be used in the composition, mention will be made of limestone amendments, organic amendmentand culture supports, root fertilizers of the NP, PK, NPK type, etc. or else root nutrient solutions.

The fertilizer can be one or more substances selected from urea, ammonium sulphate, ammonium nitrate, phosphate, phosphate salts, potassium chloride, magnesium nitrate, manganese nitrate, zinc nitrate, copper nitrate, phosphoric acid, potassium nitrate, potassium sulphate, calcium sulphate, calcium chloride and boric acid.

The biostimulant can be in solid or liquid form.

The nematostatic and/or nematicide composition allows to protect the plant against nematodes. This protection allows to improve the health of the plant, thus meeting the growth needs of the culture which will be expressed in particular in terms of improved yield and harvest quality. For example, the improvement in yield and harvest quality can be expressed by an improvement in the plant biomass produced by the plant and/or an improvement in the visual quality of the plant. Thus, the growth of the plant can be increased and/or the photosynthetic activity of the plant can be promoted (in particular by increasing the leaf chlorophyll content). The composition also allows to limit, even eliminate, the use of pesticides.

The composition can be supplied to the soil in the context of a method for treating soil to promote growth of a plant by reducing nematodes access to the roots of said plant or by eliminating nematodes present in said soil.

Use

The invention concerns a use of a red alga extract as nematostatic agent against nematodes and/or as a nematicidal agent against nematodes. The invention finding application in the agro-ecological and agricultural field, the nematodes are present in a soil.

Preferably, the red alga extract is obtained by aqueous extraction at an acid pH, for example at a pH comprised between 1 and 7, preferably between 2 and 6, even more preferably between 2 and 5, for example a pH ranging from 2.5 to 5.5, a pH ranging from 3 to 4.5, for example a pH equal to 2.5+/−0.1. The pH is measured using a pH-meter probe. The aqueous extraction at acid pH is possible with an acid solvent. The acid solvent allows to adjust the pH during the extraction to the desired pH. For example, the acid is selected from sulfuric acid (H₂SO₄), citric acid, acetic acid, preferably sulfuric acid. The amount of acid used during the extraction will be easily adjusted according to the desired final pH.

In addition, the red alga extract is advantageously obtained by aqueous extraction at a temperature ranging from 10 to 50° C., preferably ranging from 20 to 50° C., for example at a temperature ranging from 15 to 45° C., for example at 25° C., 30° C., 35° C., or 40° C.

When an acid solvent is used to obtain the red alga extract, all or part of said acid solvent is advantageously removed before using the red alga extract as nematostatic and/or nematicidal agent. For example, the acid solvent can be removed by evaporation. Thus, advantageously, the red alga extract used in the context of the present invention is devoid of acid solvent.

Independently of the use of an acid solvent during the preparation of the extract, the red alga extract used in the context of the present invention is preferably devoid of acid other than the acids naturally present in the red alga used to prepare the red alga extract. In particular, the red alga extract used in the context of the present invention is devoid of carboxylic acid, preferably the extract is devoid of carboxylic acid selected from formic acid, acetic acid, lactic acid, citric acid, oxalic acid, propionic acid, malic acid, tartaric acid, fumaric acid, gluconic acid, sorbic acid and butyric acid. In a particular embodiment, the red alga extract used in the context of the present invention is devoid of formic acid.

According to a preferred embodiment, the red alga extract is obtained by mixing crushed red algae with an acid aqueous solvent at a temperature ranging from 20 to 50° C., preferably from 40° C., and at a pH ranging from 3 to 4.5, preferably a pH of 2.5.

For example, the red alga extract is obtained by mixing dried and crushed red algae with water at a temperature of 40° C. for 3 hours, then adding sulfuric acid so that the pH of the mixture is acid, for example at pH 2.5, then centrifuging the mixture to eliminate the solid fraction and recover the liquid fraction. The liquid fraction can be used as such as red alga extract or can undergo one or more subsequent treatments, such as for example filtration and/or precipitation.

The use of red alga extract as nematostatic and/or nematicidal agent helps protect the plant against nematodes. This protection allows to improve the health of the plant, thus meeting the growth needs of the culture which will be expressed in particular in terms of improved yield and quality of the harvest. For example, the improvement in yield and in the quality of the harvest can be expressed by an improvement in the plant biomass produced by the plant and/or even an improvement in the visual quality of the plant. Thus, the growth of the plant can be increased and/or the photosynthetic activity of the plant can be promoted (in particular by increasing the leaf chlorophyll content). The use of red alga extract also allows to limit, even eliminate, the use of pesticides.

Advantageously, the red alga extract is supplied to the soil at the sowing stage, at the pre-emergence stage of the plant and/or at the post-emergence stage of the plant.

The red alga extract can be supplied to the soil in variable amounts depending on the needs of the treated plant, for example in an amount ranging from 1 to 50 kg/ha, preferably ranging from 1 to 10 kg/ha, preferably about 5 kg/ha.

The present invention finds application in the treatment of a very wide variety of plants.

Among the plants treated, mention will be made in particular of:
(i) dicots such as Solanaceae (for example tobacco, tomatoes, potatoes, aubergines, etc.), chenopodiaceae (for example sugar beets, etc.), fabaceae (for example soybeans, peas, alfalfa, etc.), cucurbits (for example melon, watermelon, cucumber, squash, etc.), crucifers or brassicas (for example rapeseed, mustard, etc.), composites (for example chicory, etc.), umbelliferae (for example carrots, cumin etc.), malvaceae (for example cotton, cocoa, okra, etc.), lamiaceae (lavender, etc.) and rosaceae in particular trees and shrubs including fruits are of economic importance; and
(ii) monocotyledons such as, for example, cereals (for example wheat, barley, oats, rice, corn, etc.) and Liliaceae (for example onions, garlic, etc.).

Advantageously, the plant belongs to the order of monocotyledons, such as the family of poaceae. Poaceae, commonly called graminaceous plants, in particular include most of the species commonly called “grasses” and “cereals”. Cereals are widely cultivated, mainly for their grains, and are used as food and animal feed.

When the plant is a poaceae, it is preferably selected from wheat, rice, barley, oats, rye, sugar cane, grassland, or corn, preferably corn.

The plant is preferably selected from soybeans, beets, corn, durum wheat, rapeseed, carrots, potatoes, solanaceae, cucurbits, lettuce or vines, preferably potatoes.

According to a particular embodiment of the invention, the use does not comprise the supply to said soil of an acid other than the acids naturally present in the red alga used to prepare the red alga extract. Preferably, the use does not comprise the supply to said soil of a carboxylic acid, for example a carboxylic acid selected from formic acid, acetic acid, lactic acid, citric acid, oxalic acid, propionic acid, malic acid, tartaric acid, fumaric acid, gluconic acid, sorbic acid and butyric acid.

Method

The invention also concerns a method for treating soil to promote growth of a plant by reducing nematodes access to the roots of said plant and/or by eliminating nematodes present in said soil, said method comprising supplying said soil with an alga extract. The characteristics of the red alga extract as described above, in particular in the “composition” and “use” part, are applicable to the method according to the invention.

The invention also concerns a method for treating soil to promote growth of a plant by reducing nematodes access to the roots of said plant and/or by eliminating nematodes present in said soil, said method comprising the supply to said soil of a composition according to the present application.

The characteristics of the composition as described above, in particular in the “composition” part, are applicable to the method according to the invention.

The red alga extract or the composition is supplied to the soil in an amount sufficient to reduce nematodes access to the roots of said plant, preferably to immobilize the nematodes present in the soil reversibly or to repel nematodes from the roots of said plant.

The red alga extract or the composition is supplied to the soil in an amount sufficient to eliminate the nematodes present in said soil, preferably to immobilize the nematodes present in the soil irreversibly. For example, the red alga extract or the composition is supplied to the soil in an amount sufficient to have a nematostatic and/or nematicidal effect of at least 10%, advantageously of at least 20%, for example at least 30%, at least 40%, at least 50%, at least 60%, at least 70%, at least 80%, at least 90% or 100%. Thus, in the context of the present invention, an amount which is effective to have a nematostatic effect allows:
(i) to immobilize at least 10% of the nematodes, advantageously at least 20%, for example at least 30%, at least 40%, at least 50%, at least 60%, at least 70%, at least 80%, at least 90% or 100% of the nematodes in an “active passage” test.
(ii) to reduce the gall index by at least 10%, advantageously by at least 20%, for example by at least 30%, by at least 50% or by at least 70%, or
(iii) to obtain a Pf/Pi ratio less than or equal to 1, preferably less than 0.8, less than 0.6, less than 0.4, or even less than 0.2.

Thus, in the context of the present invention, an amount which is effective to have a nematicidal effect allows:
(i) to irreversibly immobilize at least 10% of the nematodes, advantageously at least 20%, for example at least 30%, at least 40%, at least 50%, at least 60%, at least 70%, at least 80%, at least 90% or 100% of the nematodes in an “active passage” test.
(ii) to reduce the gall index by at least 10%, advantageously by at least 20%, for example by at least 30%, by at least 50% or by at least 70%, or
(iii) to obtain a Pf/Pi ratio less than or equal to 1, preferably less than 0.8, less than 0.6, less than 0.4, or even less than 0.2.

The method of the invention allows to protect the plant against nematodes. This protection allows to improve the health of the plant, thus meeting the growth needs of the culture which will be expressed in particular in terms of improved yield and quality of the harvest. For example, the improvement in yield and in the quality of the harvest can be expressed by an improvement in the plant biomass produced by the plant and/or even an improvement in the visual quality of the plant. Thus, the growth of the plant can be increased and/or the photosynthetic activity of the plant can be promoted (in particular by increasing the leaf chlorophyll content). The composition also allows to limit, even eliminate, the use of pesticides.

Advantageously, the red alga extract is supplied to the soil at the sowing stage, at the pre-emergence stage of the plant and/or at the post-emergence stage of the plant.

The red alga extract can be supplied to the soil in variable amounts depending on the needs of the treated plant, for example in an amount ranging from 1 to 50 kg/ha, preferably ranging from 1 to 10 kg/ha, preferably about 5 kg/ha.

The present invention finds application in the treatment of a very wide variety of plants.

Among the plants treated, mention will be made in particular of:
(i) dicots such as Solanaceae (for example tobacco, tomatoes, potatoes, aubergines, etc.), chenopodiaceae (for example sugar beets, etc.), Fabaceae (for example soybeans, peas, alfalfa, etc.), cucurbits (for example melon, watermelon, cucumber, squash, etc.), crucifers or brassicas (for example rapeseed, mustard, etc.), composites (for example chicory, etc.), Umbelliferae (for example carrots, cumin etc.), malvaceae (for example cotton, cocoa, okra, etc.), lamiaceae (lavender, etc.) and rosaceae in particular trees and shrubs including fruits are of economic importance; and
(ii) monocotyledons such as, for example, cereals (for example wheat, barley, oats, rice, corn, etc.) and Liliaceae (for example onions, garlic, etc.).

Advantageously, the plant belongs to the order of monocotyledons, such as the family of poaceae. Poaceae, commonly called graminaceous plants, in particular include most of the species commonly called “grasses” and “cereals”. Cereals are widely cultivated, mainly for their grains, and are used as food and animal feed.

When the plant is a poaceae, it is preferably selected from wheat, rice, barley, oats, rye, sugar cane, grassland, or corn, preferably corn.

The plant is preferably selected from soybeans, beets, corn, durum wheat, rapeseed, carrots, potatoes, solanaceae, cucurbits, lettuce or vines, preferably potatoes.

According to a particular embodiment of the invention, the method does not comprise the supply to said soil of an acid other than the acids naturally present in the red alga used to prepare the red alga extract. Preferably, the method does not comprise the supply to said soil of a carboxylic acid, for example a carboxylic acid selected from formic acid, acetic acid, lactic acid, citric acid, oxalic acid, propionic acid, malic acid, tartaric acid, fumaric acid, gluconic acid, sorbic acid and butyric acid.

### BRIEF DESCRIPTION OF THE DRAWINGS

FIG. 1: FIG. 1 shows the development cycle of a nematode. The first stage corresponds to the egg, then the larval development stages L1, L2, L3 and L4, and the two stages of development of the adult nematode (called L5 and adult).

FIG. 2: FIG. 2 shows a diagram of preparation of a Porphyra spp red alga extract type.

FIG. 3A: FIG. 3A shows an experimental device for monitoring the mobility of nematodes called an immobilization test, in order to measure the nematostatic and/or nematicidal effect of a red alga extract. After contacting the nematodes with a red alga extract, the nematodes were transferred to a porous membrane and their mobility was monitored over time (T1, T2) to determine whether they were reversibly and/or irreversibly immobilized.

FIG. 3B: FIG. 3B shows the monitoring of the behavior of the nematode larvae over time (in days) after contacting the larvae with a red alga extract. The behavior of the nematode larvae reflects a specific action of the extract vis-h-vis the different groups of nematodes. The percentage of immobilized larvae at the stage L2 (or J2) is expressed as a function of the number of days after immobilization of the larvae. Three behaviors of the larvae were observed over time (in days): i) a nematostatic effect, when the nematode larvae regained their mobility during time; (ii) a nematicidal effect when the nematode larvae have not regained their mobility during time, and (iii) a nematostatic effect and a nematicidal effect when a first fraction of nematode larvae has not recovered its mobility after a few days and a second fraction of nematode larvae regained mobility.

FIG. 4: FIG. 4 shows the measurement of the gall index on tomato roots at jar+30, after tomato plants infected with larvae at the development stage L2 of the Meloidogyne incognita type were treated with a solution of Porphyra spp red alga extract at 15.8 g/L (NEMA 15.8 g/L), with a solution of Porphyra spp red alga extract at 31.6 g/L (NEMA 31.6 g/L) or received no treatment (NT Control).

FIG. 5: FIG. 5 shows the average leaf biomass in grams of tomato plants at jar+30, after tomato plants infected with larvae at the development stage L2 of the Meloidogyne incognita type were treated with a solution of Porphyra spp red alga extract at 15.8 g/L (NEMA 15.8 g/L), with a solution of Porphyra spp red alga extract at 31.6 g/L (NEMA 31.6 g/L) or received no treatment (NT Control).

FIG. 6: FIG. 6 shows the chlorophyll content of tomato leaf tissue at jar+30, in Arbitrary Unit AU, after tomato plants infected with larvae at the development stage L2 of the Meloidogyne incognita type were treated with a solution of Porphyra spp red alga extract at 15.8 g/L (NEMA 15.8 g/L), with a solution of Porphyra spp red alga extract at 31.6 g/L (NEMA 31.6 g/L) or received no treatment (NT Control).

FIG. 7: FIG. 7 shows the number of Heterodera schachtii cysts present in the soil during the harvest of beets at jar+36, after beet plants infected with larvae at the development stage L2 and eggs from Heterodera schachtii were treated with a solution of Porphyra spp red alga extract at 15.8 g/L (NEMA 15.8 g/L), with a solution of Porphyra spp red alga extract at 31.6 g/L (NEMA 31.6 g/L) or received no treatment (NT Control).

FIG. 8: FIG. 8 shows the amount of foliar biomass of beets at jar+36, after beet plants infected with larvae at the development stage L2 and eggs from Heterodera schachtii were treated with a solution of Porphyra spp red alga extract at 15.8 g/L (NEMA 15.8 g/L), with a solution of Porphyra spp red alga extract at 31.6 g/L (NEMA 31.6 g/L) or received no treatment (NT Control).

FIG. 9: FIG. 9 shows the amount of root biomass of beets at jar+36, after beet plants infected with larvae at the development stage L2 and eggs from Heterodera schachtii were treated with a solution of Porphyra spp red alga extract at 15.8 g/L (NEMA 15.8 g/L), with a solution of Porphyra spp red alga extract at 31.6 g/L (NEMA 31.6 g/L) or received no treatment (NT Control).

FIG. 10: FIG. 10 shows the chlorophyll content of beet leaf tissue at jar+36, after beet plants infected with larvae at the development stage L2 and eggs from Heterodera schachtii were treated with a solution of Porphyra spp red alga extract at 15.8 g/L (NEMA 15.8 g/L), with a solution of Porphyra spp red alga extract at 31.6 g/L (NEMA 31.6 g/L) or received no treatment (NT Control).

FIG. 11: FIG. 11 shows the measurement of the gall index on potato plants at jar+57 (BBCH43), after potato plants infected with larvae at the development stage L2 of Meloidogyne spp were treated with a solution of Porphyra spp red alga extract at 30 g/L, with a solution of Porphyra spp red alga extract at 60 g/L, or received no treatment (NT control).

FIG. 12: FIG. 12 shows the number of nematodes in the soil during the potato harvest at jas+108; BBCH49, after potato plants infected with larvae at the development stage L2 of Meloidogyne spp were treated with a solution of Porphyra spp red alga extract at 30 g/L, with a solution of Porphyra spp red alga extract at 60 g/L, or received no treatment (NT control).

FIG. 13: FIG. 13 shows the chlorophyll content measured in Arbitrary Units (AU) measured on the leaf tissues of potato plants at jar+44 (BBCH40), after potato plants infected with larvae at the development stage L2 of Meloidogyne spp were treated with a solution of Porphyra spp red alga extract at 30 g/L, with a solution of Porphyra spp red alga extract at 60 g/L, or received no treatment (NT control).

FIG. 14: FIG. 14 shows the yield in kg for twenty linear meters at the harvest of potatoes at jar+108, after potato plants infected with larvae at the development stage L2 of Meloidogyne spp were treated with a solution of Porphyra spp red alga extract at 30 g/L, with a solution of Porphyra spp red alga extract at 60 g/L, or received no treatment (NT control).

FIG. 15: FIG. 15 shows the number of Globodera rostochiensis and Globodera pallida cysts counted at the potato harvest, after potato plants infected with Globodera rostochiensis and Globodera pallida nematodes were treated with a solution of Porphyra spp red alga extract at 30 g/L, with a solution of Porphyra spp red alga extract at 60 g/L, or received no treatment (NT control).

FIG. 16: FIG. 16 shows the Pf/Pi ratio of Globodera rostochiensis and Globodera pallida cysts at potato harvest, after potato plants infected with Globodera rostochiensis and Globodera pallida nematodes were treated with a solution of Porphyra spp red alga extract at 30 g/L, with a solution of Porphyra spp red alga extract at 60 g/L, or received no treatment (NT control).

FIG. 17: FIG. 17 shows the harvest yield of potatoes in ton/hectare, after potato plants infected with Globodera rostochiensis and Globodera pallida nematodes were treated with a solution of Porphyra spp red alga extract at 30 g/L, with a solution of Porphyra spp red alga extract at 60 g/L, or received no treatment (NT control).

FIG. 18: FIG. 18 shows the average amount of tubers in tons/hectare according to tuber sizes (size less than 28 mm, size comprised between 28 and 40 mm, size comprised between 40 and 50 mm, size comprised between 50 and 60 mm), after potato plants infected with Globodera rostochiensis and Globodera pallida nematodes were treated with a 30 g/L solution of Porphyra spp red alga extract, with a solution of Porphyra spp red alga extract at 60 g/L, or received no treatment (NT control).

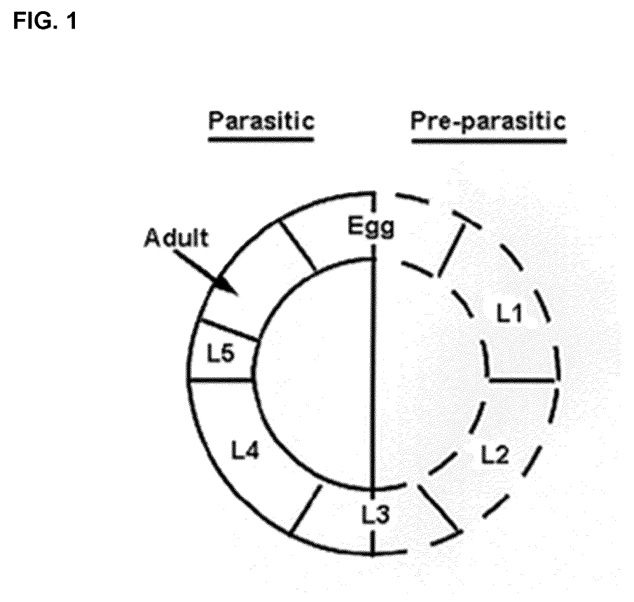

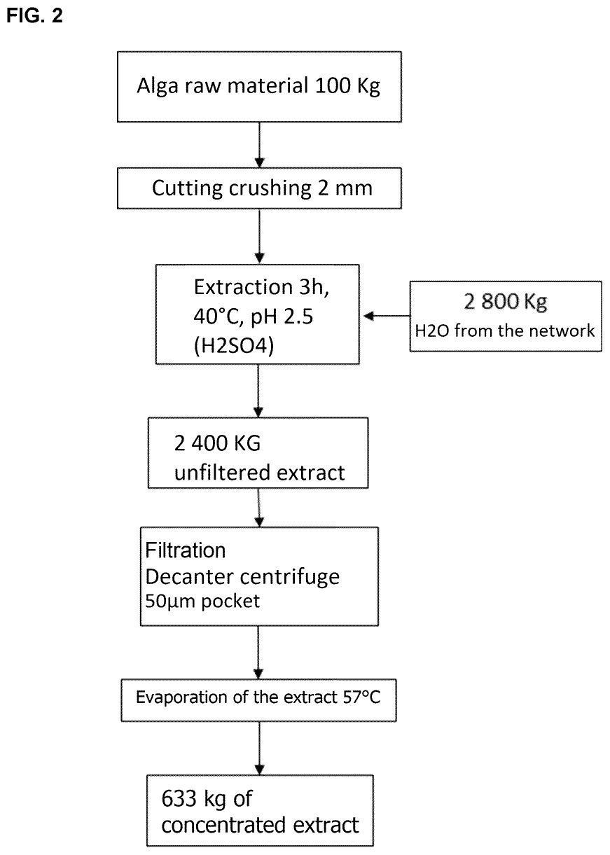

### EXAMPLES

### Example 1: Preparation of a Red Alga Extract for its Use According to the Invention

### Example 1A: Preparation of a Red Alga Extract of the Porphyra Spp Type (Also Called Pyropia Spp) for its Use According to the Invention

Method

An extract of Porphyra spp (also called Pyropia spp) was prepared using the following method:
Step 1: 100 kg of dried red alga of the Porphyra spp type were crushed and passed through a sieve in order to obtain fragments of a size less than or equal to 2 mm.
Step 2: the 100 kg of dried and crushed red alga obtained in step 1 were mixed with 2800 kg of water and 5 kg of sulfuric acid (H₂SO₄) at 40° C. The mixture was stirred at a temperature of 40° C. and at a pH of 2.5, for 3 hours.
Step 3: the mixture obtained in step 2 (2400 kg) was centrifuged using an industrial decanter centrifuge, then the supernatant was filtered at 50 μm. The extract was then concentrated by evaporation at a temperature below 57° C., in order to obtain 640 kg of concentrated liquid extract comprising 8% of dry matter (that is to say 80 g of dry matter per liter of concentrated extract). The concentrated extract thus obtained corresponds to the extract used in the examples below.

### Example 1B: Preparation of a Red Alga Extract of Palmaria Spp Type for its Use According to the Invention

Method

An extract of Palmaria spp was prepared using the following method:
Step 1: 100 kg of dried red alga of Palmaria spp type were crushed and passed through a sieve to obtain fragments of size less than or equal to 2 mm.
Step 2: the 100 kg of dried and crushed red alga obtained in step 1 were mixed with 900 kg of water and 1.4 kg of sulfuric acid (H₂SO₄). The mixture was stirred at a temperature of 40° C. and at a pH of 2.5, for 3 hours.
Step 3: the mixture obtained in step 2 (880 kg) was centrifuged using an industrial decanter centrifuge, then the supernatant was filtered at 50 μm. The extract was then concentrated by evaporation at a temperature below 60° C., in order to obtain 446 kg of concentrated liquid extract comprising 11% of dry matter (that is to say 110 g of dry matter per liter of concentrated extract). The concentrated extract thus obtained corresponds to the extract used in Example 2 below.

### Example 2: Nematostatic and/or Nematicidal Effects of a Porphyra Spp Red Alga Extract (Pyropia Spp) and a Palmaria Spp Red Alga Extract on Different Nematodes

Experimental Conditions:

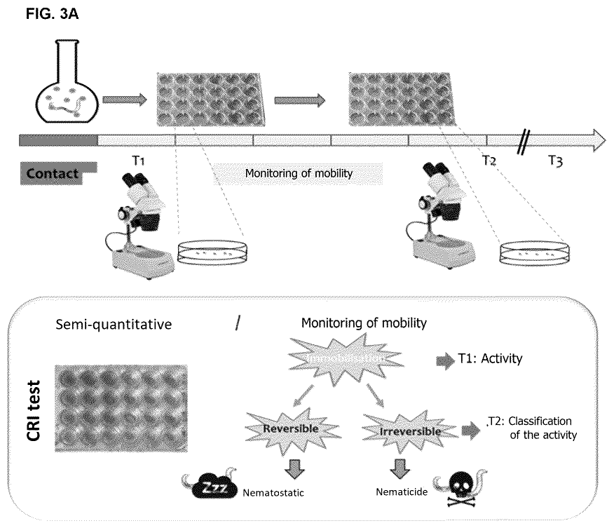

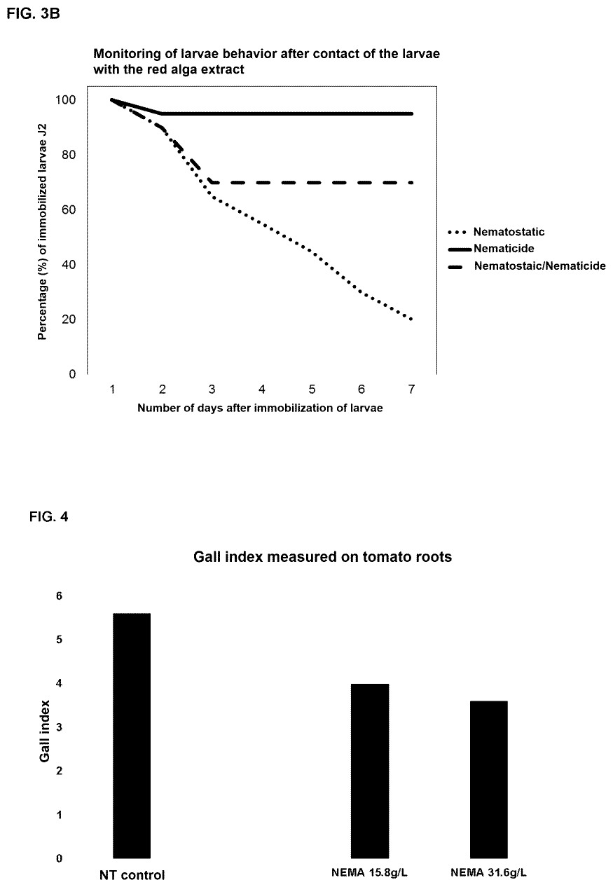

A nematode larvae immobilization test was carried out in order to measure the nematostatic and/or nematicidal effect of each of the red alga extracts (Porphyra spp and Palmaria spp). This test allowed to determine the behavior of nematode larvae (at the larval stage L2 also called the juvenile stage J2) when they were contacted with the red alga extract then transferred to a porous membrane as described in FIG. 3A.

The tests were carried out on nematode larvae belonging to the groups of facultative plant-parasitic nematodes (Ditylenchus dispaci Xiphinema index), and groups of obligate plant-parasitic nematodes (Meloidogyne javanica, Heterodera carotae, Heterodera schachtii Globodera pallida).

The mobility of the nematodes was analyzed in order to determine whether the extract had a nematicidal and/or nematostatic effect.

FIG. 3B shows that the nematodes reacted in three different ways, once contacted with the red alga extract:
A proportion of nematodes did not regain their mobility, and were unable to pass through the porous membrane, which reflects the nematicidal effect of the red alga extract.
A proportion of nematodes regained their mobility after 4 days then after seven days, and were able to pass through the porous membrane, which reflects the nematostatic effect of the red alga extract.
A first fraction of nematodes did not regain its mobility after four days, and was unable to pass through the porous membrane. A second fraction of nematodes has regained its mobility. In this case, the red alga extract therefore had a nematicidal and nematostatic effect.

In the control condition, the nematode lavas contacted with water (instead of the red alga extract), then transferred to a porous membrane, then rinsed with water, immediately regained their mobility and passed through the porous membrane.

The results of the immobilization test carried out with the red alga extract of the Porphyra spp type are presented in Table 1.

TABLE 1

| | Sedentary plant parasites | | | | Optional plant parasites | |
|---|---|---|---|---|---|---|
| | Meloidogyne | Globedera | Heterodera | Heterodera | Xiphinema | Ditylenchus |
| | javanica | pallida | schachtii | carotae | index | dispaci |
| Nematicidal effect | Yes | | | | | |
| Nematostatic effect | | | Yes | Yes | Yes | |
| Nematicidal and | | Yes | | | | Yes |
| nematostatic effect | | | | | | |

The larvae of nematodes of the genus Meloidogyne (sedentary endoparasitic nematode, gall nematode) were irreversibly immobilized, which reflects the nematicidal effect of the red alga extract prepared according to Example 1A on this group of nematodes.

A fraction of nematode larvae of the genus Globodera (sedentary endoparasitic nematode, cyst nematode) was immobilized irreversibly. The other fraction of nematode larvae has regained its mobility. This reflects the nematicidal and nematostatic effect of the red alga extract prepared according to Example 1A on this group of nematodes.

The larvae of nematodes of the genus Heterodera (sedentary endoparasitic nematode, cyst nematode) were immobilized reversibly, which reflects the nematostatic effect of the red alga extract prepared according to Example 1A on this group of nematodes.

The larvae of nematodes of the genus Xiphinema (migratory plant-parasitic nematode) were immobilized reversibly, reflecting the nematostatic effect of the red alga extract prepared according to Example 1A on this group of nematodes.

A fraction of the nematode larvae of the genus Ditylenchus (facultative plant-parasitic nematode) was irreversibly immobilized. The other fraction of nematode larvae regained its mobility. This reflects the nematicidal and nematostatic effect of the red alga extract prepared according to Example 1A on this group of nematodes.

The results of the immobilization test carried out with the red alga extract of Palmaria spp type are shown in Table 2.

TABLE 2

| | Sedentary plant parasites | | | | Optional plant parasites | |
|---|---|---|---|---|---|---|
| | Meloidogyne | Globedera | Heterodera | Heterodera | Xiphinema | Ditylenchus |
| | javanica | pallida | schachtii | carotae | index | dispaci |
| Nematicidal effect | Yes | Yes | | | not tested | not tested |
| Nematostatic effect | | | | | not tested | not tested |
| Nematicidal and | | | | Yes | not tested | not tested |
| nematostatic effect | | | | | | |

The larvae of nematodes of the genus Meloidogyne (sedentary endoparasitic nematode, gall nematode) were irreversibly immobilized, which reflects the nematicidal effect of the red alga extract prepared according to Example 1B on this group of nematodes.

The larvae of nematodes of the genus Globodera (sedentary endoparasitic nematode, cyst nematode) were irreversibly immobilized, which reflects the nematicidal effect of the red alga extract prepared according to Example 1B on this group of nematodes.

The larvae of nematodes of the genus Heterodera (sedentary endoparasitic nematode, cyst nematode) were immobilized irreversibly. The other fraction of nematode larvae regained its mobility. This reflects the nematostatic and nematicidal effect of the red alga extract prepared according to Example 1B on this group of nematodes.

### Example 3: Demonstration, in Experimental Greenhouses (that is to Say Under Controlled Conditions), of the Effects of a Porphyra Spp Red Alga Extract on the Infestation of Tomato Plants Infected with Nematode Larvae at the Development Stage L2 of the Genus Meloidogyne Incognita

Experimental Conditions

The test was carried out in an experimental research greenhouse so as to evaluate the effectiveness of the red alga extract of Example 1A (Porphyra spp red alga extract) on tomato plants (Solanum lycopersicum) transferred in sandy soil infested with nematode larvae of Meloidogyne incognita at the development stage L2 in an amount of 0.8 larvae per mL of sandy soil. The tomato variety used for this test was the 505 F1 variety, susceptible to Meloidogyne incognito attack. This nematode has the ability to attack the roots of tomato plants, causing galls to form on the roots, and indirectly reducing the development of the tomato plant, the aerial biomass of the tomato plant, the efficiency of the photosynthetic activity (chlorophyll content of the leaves) and therefore the quality of production.

The concentrated red alga extract of Example 1A was diluted in water to obtain a first solution at a concentration of 15.8 grams of concentrated extract per liter of solution (g/L) (comprising 1.58% concentrated extract in the first solution) and a second solution at a concentration of 31.6 g/L (comprising 3.16% of concentrated extract in the second solution). The two solutions were applied to the surface of the sandy soil infested with nematode larvae 5 days before transplanting (jar−5) the tomato plants, 1 day after transplanting, (jar+1), at jar+3, at jar+6, at jar+9 and at jar+12. 6 tomato plants were tested for each modality. At the end of the test (jar+30), the roots of the tomato plants were recovered and the gall index was determined. The gall index is a system for measuring the level of infestation of a root by gall nematodes, allowing in this case to measure the infestation of Meloidogyne incognito. On a scale of 1 to 6, the gall index provides information on the level of infestation (1-2: 0-10% infestation; 2-3: 10-20% infestation; 3-4: 20-50% infestation; 4-5: 50-80% infestation; 5-6: 80-100% infestation).

In parallel, the height of the tomato plants and the aerial biomass were measured at the end of the test. Similarly, the chlorophyll content was determined.

Results

The results presenting the gall index, on tomato roots at jar+30, are shown in FIG. 4. They show that in the absence of treatment (non-treated control; NT control), the gall index reaches the value of 5.6, which means that 80 to 100% of the roots of the tomato plants were covered with galls. When the concentrated solution at 15.8 g/L was applied, the gall index was 4, that is to say an infestation of approximately 50%. When the concentrated solution at 31.6 g/L was applied, the gall index was 3.6, representing an infestation of 20-50%. This shows that the use of a red alga extract according to the invention allows a significant reduction in the gall index, in a dose-dependent manner.

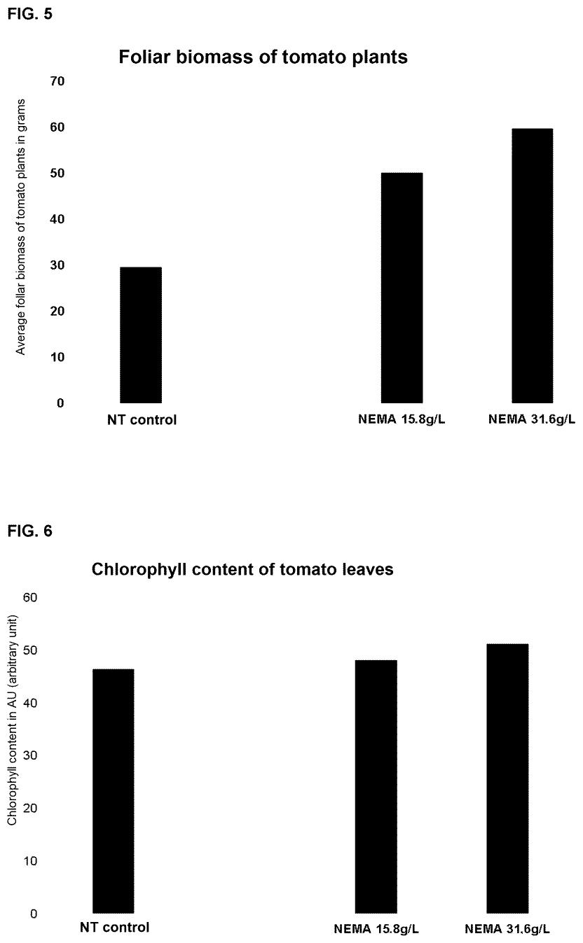

The results showing the amount of leaf biomass of tomato plants at jar+30 are shown in FIG. 5. They show that in the absence of treatment (non-treated control; NT control), the tomato plants developed a leaf biomass of 30 g on average per tomato plant).

When the concentrated solutions at 15.8 g/L and 31.6 g/L were applied, the amount of leaf biomass was significantly higher than the biomass of the NT control (respectively 50 g and 60 g on average per tomato plant). This shows that the use of a red alga extract according to the invention allows to reduce the infestation of nematodes, which had a direct consequence on the amount of leaf biomass produced by the tomato plants, in a dose dependent manner.

The results showing the chlorophyll content of the leaf tissues of tomato plants at jar+30 are shown in FIG. 6. They show that in the absence of treatment (non-treated control; NT control), the tomato plants had a chlorophyll content of 46 AU (Arbitrary Unit) on average per tomato plant. When the concentrated solutions of 15.8 g/L and 31.6 g/L were applied, the chlorophyll content was respectively 48 AU and 52 AU on average per tomato plant. This increase in chlorophyll content of the leaf tissues is correlated with the increase in leaf biomass.

### Example 4: Demonstration, in Experimental Greenhouses (that is to Say Under Controlled Conditions), of the Effects of a Porphyra Spp Red Alga Extract on Infestation of Beet Plants Infected with Heterodera schachtii Nematode Larvae at the Development Stage L2 and Effect on Cyst Production by Heterodera schachtii Nematode Larvae

Experimental Conditions

The test was carried out in an experimental research greenhouse in order to evaluate the effectiveness of a red alga extract prepared according to Example 1A (Porphyra spp red alga extract) on beet plants (Beta vulgaris) transferred to sandy soil infested with 100-150 Heterodera schachtii larvae and cysts per 100 mL of sandy soil. The beet variety used for this test was the Fiametta variety, which is susceptible to Heterodera schachtii attack. This nematode infests the roots of beet to reproduce therein, thus altering leaf biomass, root biomass, and chlorophyll content. The result is an alteration in the production and quality of the beets. Heterodera schachtii has the particularity of producing at the end of its complete infestation cycle, a new generation of cysts. This generation of cysts will produce larvae which in turn will infest the beet plants.

The concentrated red alga extract prepared according to Example 1A was diluted in water in order to obtain a first solution at a concentration of 15.8 g of concentrated extract per liter of solution (g/L) (comprising 1.58% of concentrated extract) and a second solution at a concentration of 31.6 g/L (comprising 3.16% of concentrated extract). The two solutions were applied 2 days after the sowing stage (jas+2) of the beet seeds, at jas+4, at jar+7, at jar+6, at jar+10 and at jar+13. 4 independent blocks sown with beet seeds of Fiametta variety were tested for each modality.

At the end of the test (jar+36), the roots of the beet plants were recovered and the amount of cysts produced was determined. In parallel, the height of the beet plants, the leaf biomass and the root biomass were also measured at the end of the test. Similarly, the chlorophyll content was determined.

Results

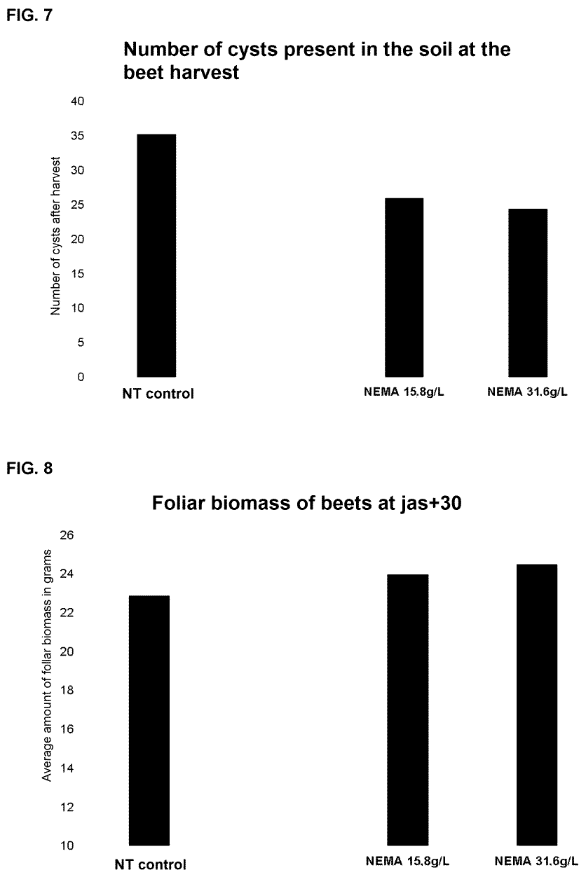

The results showing the number of Heterodera schachtii cysts produced at the end of the test, at jar+36, are shown in FIG. 7. They show that in the absence of treatment (Non-treated control; NT control), the average number of cysts produced was 35 cysts for 100 mL of soil. When the 15.8 g/L and 31.6 g/L solutions were applied, the average number of cysts produced was 26 cysts and 23 cysts, respectively. This reduction in the number of cysts produced reflects a significant reduction in the number of larvae at the development stage L2 having infected the beet roots after treatment with the two solutions, in a dose-dependent manner.

The results showing the amount of leaf biomass of the beet plants at jar+36 are shown in FIG. 8. They show that in the absence of treatment (non-treated control; NT control), the beet plants developed a leaf biomass of 23 g on average per plant. When the 15.8 g/L and 31.6 g/L solutions were applied, the amount of leaf biomass produced was 24 g and 24.5 g, respectively, on average per beet plant. This increase in the amount of leaf biomass compared to the NT control indirectly reflects a reduction in the intensity of the attack of the Heterodera schachtii nematode larvae and eggs.

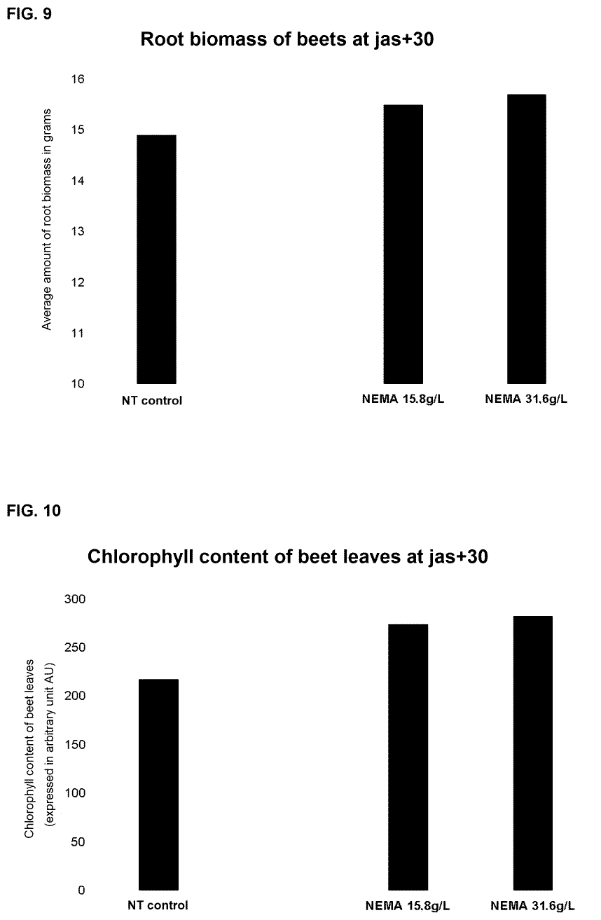

The results showing the amount of root biomass of beet plants at jar+36 are shown in FIG. 9. They show that in the absence of treatment (non-treated control; NT control), the beet plants developed a root biomass of 15 g on average per plant. When the 15.8 g/L and 31.6 g/L solutions were applied to beet plants, the amount of root biomass produced was 15.5 g and 15.7 g, respectively, on average per beet plant. This increase in the amount of root biomass produced indirectly reflects a reduction in the intensity of the attack of the of the Heterodera schachtii nematode larvae and eggs.

The results showing the chlorophyll content of the leaf tissues of the beet plants at jar+36 are shown in FIG. 10. They show that in the absence of treatment (non-treated control; NT control), the beet plants had a chlorophyll content of 220 AU on average per plant. When the 15.8 g/L and 31.6 g/L solutions were applied to the plants, the chlorophyll content was respectively 260 AU and 265 AU on average per beet plant. This increase in the chlorophyll content of the leaf tissues stems from the increase in the leaf biomass produced after the use of a red alga extract, in a dose-dependent manner.

### Example 5: Demonstration, in the Open Field, of a Porphyra Spp Red Alga Extract on the Infestation of Potato Plants Infected with Meloidogyne Spp Nematode larvae at the development stage L2

Experimental Conditions

The test was carried out in the open field, on plots previously selected for the presence of Meloidogyne incognita nematodes, so as to evaluate the effectiveness of the red alga extract prepared according to Example 1A (Porphyra spp red alga extract) on potato plants (Solanum tuberosum). The potato variety used for this test was the AGRIA variety, a variety susceptible to Meloidogyne incognito attack. This nematode infests potato roots, causing gall formation on the roots, and indirectly reducing the development of the potato plant, the aerial biomass of the potato plant, the efficiency of the photosynthetic activity (chlorophyll content of the leaves) and therefore the quality of production.

The concentrated red alga extract prepared according to Example 1A was diluted in water in order to obtain a first solution at a concentration of 30 g of concentrated extract per liter of solution (g/L) (comprising 3% of concentrated extract) and a second solution at a concentration of 60 g/L (comprising 6% of concentrated extract).

The two solutions were applied 1 day after the sowing stage, (jas+1), at jar+15, at jar+30, at jar+45 and at jar+60. The gall index is a system for measuring the level of infestation of a root by larvae at the development stage L2 of gall nematodes, of the incognita Meloidogyne type, as described in Example 3. The number of nematode larvae of the genus Meloidogyne was determined in soil samples. The chlorophyll content of the leaf tissues of potato plants at jar+44 (BBCH40) was determined. Finally, the potato tubers were recovered and classified according to their size.

Results

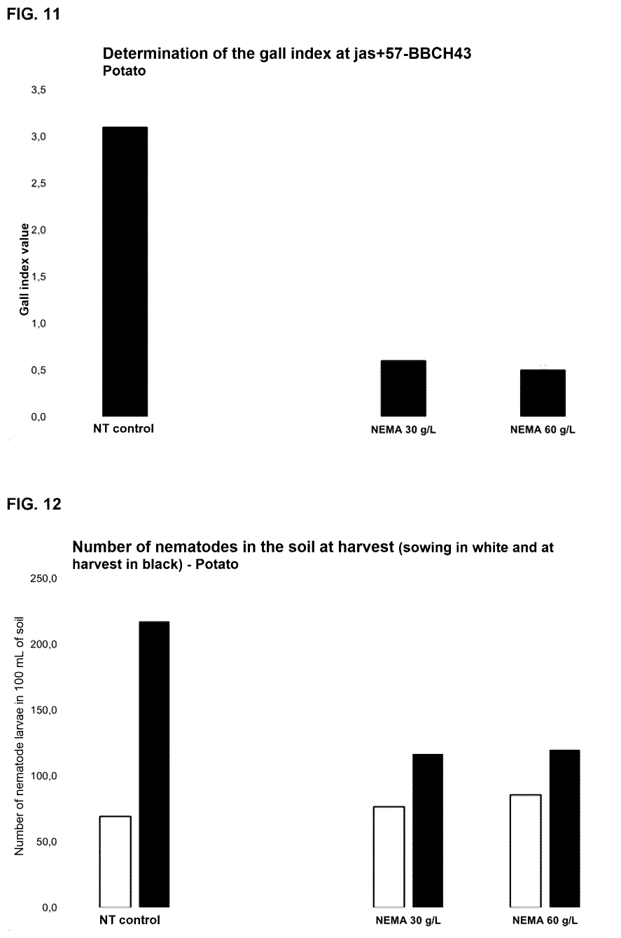

The results showing the gall index, at jar+57 (BBCH43), are shown in FIG. 11. They show that in the absence of treatment, the gall index was 3.0. When the 30 g/L and 60 g/L solutions were applied to the potato plants, the gall index was 0.6 and 0.5 respectively.

This decrease in the gall index shows the effect of the red alga extract at the two concentrations tested.

The results showing the amount of nematodes present in the soils at harvest (jas+108; BBCH49) are shown in FIG. 12. They show that in the absence of treatment, the soil samples contained a population of nematodes at harvest four times higher than the nematode population on the day of sowing (210 larvae at nematode harvest against 55 larvae on the day of sowing). This value of the number of larvae reflects the intensity of the infestation in the absence of treatment. When the 30 g/L and 60 g/L solutions were applied, the amount of nematodes was respectively 110 nematode larvae at harvest against 60 larvae at sowing (that is to say a reproduction dynamic of 1.5) and 120 nematode larvae at harvest versus 85 larvae at sowing (that is to say a reproduction dynamic of 1.4).

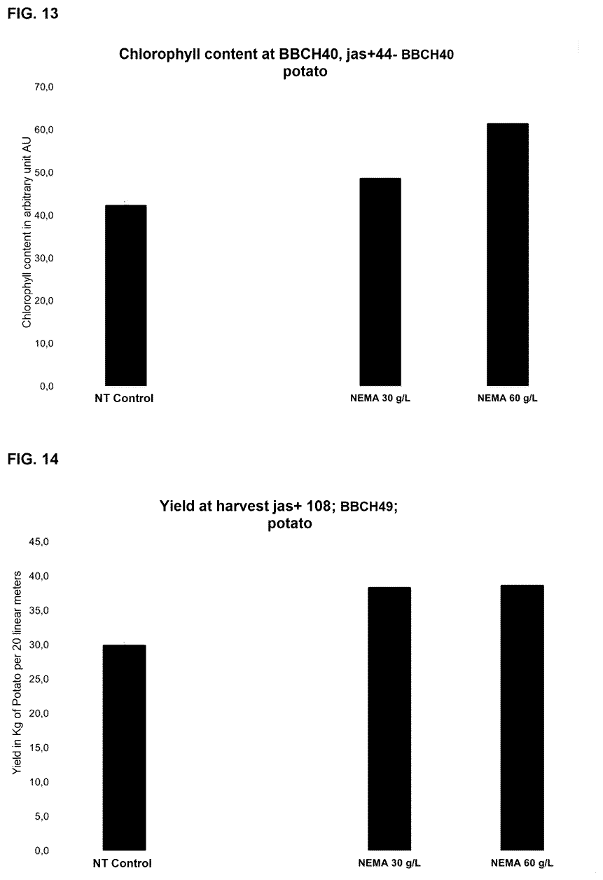

The results showing the chlorophyll content of the leaf tissues of potato plants at jar+44 (BBCH40) are shown in FIG. 13. They show that in the absence of treatment (non-treated control; NT control), the potato plants soil had an average chlorophyll content of 42 AU per plant. When the 30 g/L and 60 g/L solutions were applied to the plants, the chlorophyll content was 48 AU and 61 AU respectively.

The results showing the yield at harvest at jar+108 are shown in FIG. 14. They show that in the absence of treatment (non-treated control; NT control), the potato yield reached the value of 30 kg of potato for 20 linear meters. When the 30 g/L and 60 g/L solutions were applied to the plants, the potato yield was 38.3 Kg of potato per 20 linear meters and 38.6 Kg of potato for 20 linear meters, respectively.

### Example 6: Demonstration, in the Open Field, of the Effects of a Porphyra Spp Red Alga Extract on the Infestation of Potato Plants by Nematodes of the Globodera pallida and Globodera rostochiensis Genera

Experimental Conditions

A test aiming at evaluating the effectiveness of a red alga extract prepared according to Example 1A (Porphyra spp red alga extract) on a potato crop of Agata variety in the open field, was carried out on a plot having Globodera rostochiensis infestation rates of 24.7 cysts per 100 mL of soil and 23.7 cysts of Globodera pallida per 100 mL of soil. The potato variety used was the Agata variety, a variety susceptible to attack by the two cyst nematodes mentioned above. The larvae at the development stage L2 infest tubers and young potato roots, reproduce therein, thus altering the production and quality of the potato (leaf biomass, root biomass, chlorophyll content). These cyst nematodes have the particularity of producing, at the end of their complete infestation cycle, a new generation of cysts. This generation of cysts will produce larvae which in turn will infest the potato plants.

The concentrated red alga extract prepared according to Example 1A was diluted in water in order to obtain a first solution at a concentration of 30 g of concentrated extract per liter of solution (g/L) (comprising 3% concentrated extract) and a second solution at a concentration of 60 g/L (comprising 6% concentrated extract).

The two solutions were applied at the sowing stage of the potato tubers (jas+10), at jas+20, at jas+30, at jas+35, at jas+40. The experimental device was carried out according to a Fisher block design with four completely random repetitions in the field.

At harvest, the potato root tubers were collected and classified according to their size.

The amount of cysts in the soil was determined at harvest. Similarly, the Pf/Pi ratio was determined. The Pf/Pi ratio (number of cysts counted at harvest Pf, divided by the number of cysts counted at the sowing stage Pi) provides information on the effectiveness of the treatment in disrupting the infectious cycle of the nematode, and in reducing the amount of cysts present in the soil after harvest. The potato yield was also determined. Finally, the potato tubers were collected and classified according to their size.

Results

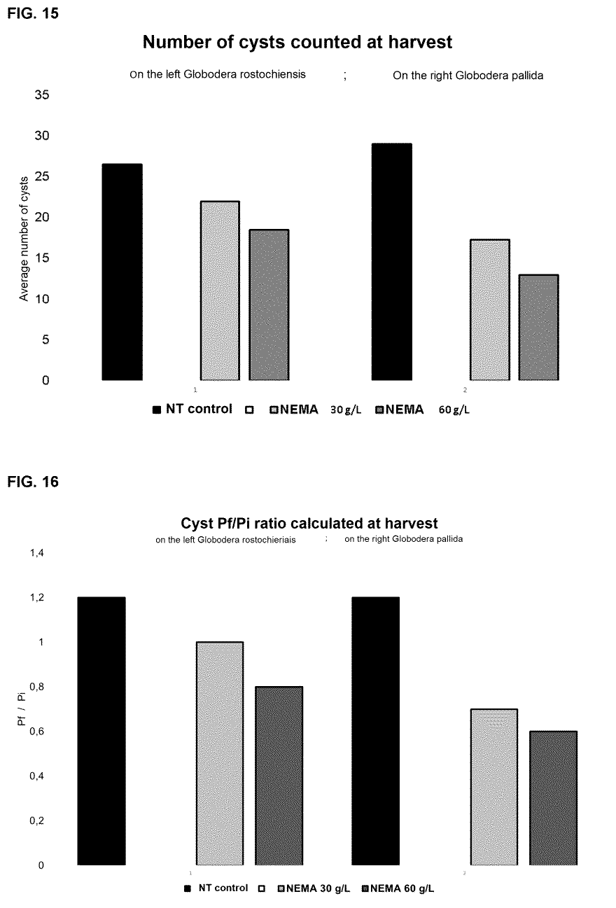

The results showing the number of Globodera rostochiensis and Globodera pallida cysts produced at the end of the test, at harvest, are shown in FIG. 15. They show that in the absence of treatment (non-treated control; NT control), the average number of cysts counted was 26 and 29 cysts per 100 mL soil for Globodera rostochiensis and Globodera pallida respectively. When the 30 g/L solution was applied to the plants, the number of cysts counted was 22 and 17 cysts per 100 mL of soil for Globodera rostochiensis and Globodera pallida respectively. When the 60 g/L solution was applied to the plants, the number of cysts counted was 19 and 12 cysts per 100 mL of soil, for Globodera rostochiensis and Globodera pallida respectively. This reduction in the number of cysts shows the reduction in the number of larvae at the development stage L2 having infected the roots of the potato plants, after the use of a red alga extract according to the invention.

The results showing the Pf/Pi ratio of the number of Globodera cysts rostochiensis and Globodera pallida produced at the end of the test, at harvest, are shown in FIG. 16. They show that in the absence of treatment (non-treated control; NT control), the Pf/Pi was 1.2 for Globodera rostochiensis and Globodera pallida. When the 30 g/L solution was applied to the plants, the Pf/Pi ratio of the number of cysts was 1 and 0.7 for Globodera rostochiensis and Globodera pallida respectively. When the 60 g/L solution was applied to the plants, the Pf/Pi ratio of the number of cysts was 0.8 and 0.6 for Globodera rostochiensis and Globodera pallida respectively. This significant decrease in the Pf/Pi ratio shows the effect of a red alga extract against Globodera rostochiensis and Globodera pallida nematodes.

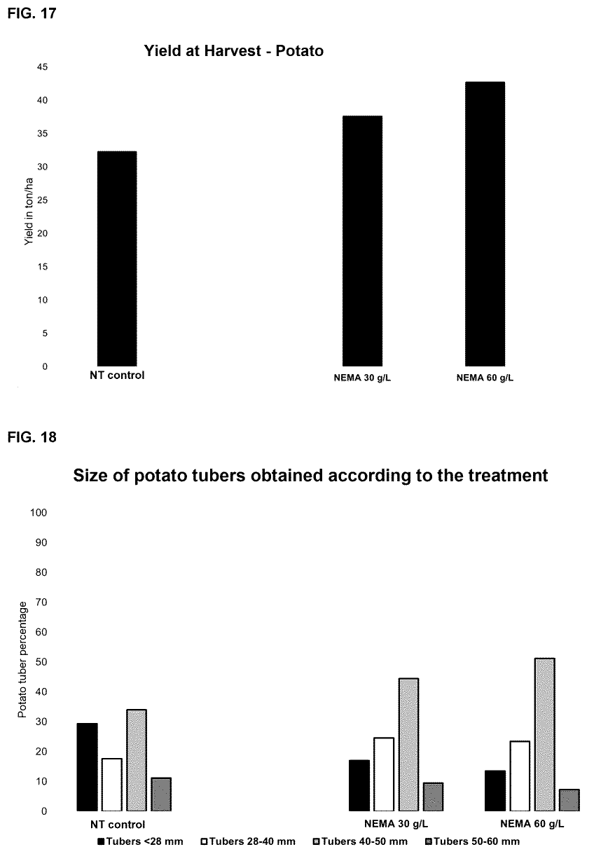

The results showing the yield at harvest are shown in FIG. 17. They show that in the absence of treatment (Non-treated control; NT control), the potato yield reached 31 tons/ha. When the 30 g/L and 60 g/L solutions were applied to the plants, the yield was 39 tons/ha and 41 tons/ha respectively. This increase in yield indirectly reflects a reduction in the intensity of attack of the Globodera rostochiensis and Globodera pallida nematodes, after the use of a red alga extract according to the invention.

The results showing harvest quality are shown in FIG. 18. Here, the harvest quality was characterized by the size of potato tubers at harvest. The higher the size, the better the quality of the harvest. The results obtained show that in the absence of treatment (non-treated control; NT control), the proportion of tubers with a size less than 40 mm was 15%. For the control, the proportion of tubers with a size comprised between 40 and 50 mm, between 50 and 60 mm, then greater than 60 mm, was respectively 11%, 4 and 2%. When the 30 g/L and 60 g/L solutions were applied to the plants, a greater proportion of tubers with a size greater than 40 mm was observed (see Table 2, respectively 23% and 27% against 17% for the control).

TABLE 3

| | Control | 30 g/L extract | 60 g/L extract |
|---|---|---|---|
| | Condition | solution | solution |
| | Number of | Number of | Number of |
| Size of potato tubers | tubers in % | tubers in % | tubers in % |
| Less than 28 mm | 10% | 7% | 6% |
| Comprised between | 5% | 9% | 10% |
| 28 and 40 mm | | | |
| Comprised between | 11% | 17% | 22% |
| 40 and 50 mm | | | |
| Comprised between | 4% | 4% | 3% |
| 50 and 60 mm | | | |
| Greater than 60 mm | 2% | 2% | 2% |

1. (canceled)

2. A method for treating soil to promote growth of a plant by reducing nematodes access to the roots of said plant and/or by eliminating nematodes present in said soil, said method comprising supplying said soil with a red alga extract.

3. The method according to claim 2, wherein the red alga is selected from Porphyra spp, Porphyra columbina, Porphyra acanthophora, Porphyra tenera, Porphyra perforata, Porphyra vietnamensis, Porphyra rosengurttii, Porphyra yezoensis, Porphyra haitanensis, even more preferably Porphyra spp or Porphyra columbina.

4. The method according to claim 2, wherein the red alga extract is obtained by aqueous extraction at an acidic pH.

5. The method according to claim 2, wherein the red alga extract is obtained by aqueous extraction at a pH comprised between 1 and 7, preferably between 2 and 6, even more preferably between 2 and 5.

6. The method according to claim 2, wherein the red alga extract is obtained by aqueous extraction at a temperature comprised between and 50° C., preferably between 20 and 50° C.

7. The method according to claim 2, wherein the nematodes are pathogenic nematodes, preferably selected from the families Anguinidae, Longidoridae, Tylenchulidae, Pratylenchidae, Hoplolaimidae, Tylenchulidae, Trichodoridae, Heterodoridae, and Meloidogynidae.

8. The method according to claim 2, wherein the extract is supplied to the soil at the sowing stage, at the pre-emergence stage of the plant and/or at the post-emergence stage of the plant.

9. The method according to claim 2, wherein the extract is supplied to the soil in an amount ranging from 1 to 50 kg/ha, preferably ranging from 1 to 10 kg/ha, preferably about 5 kg/Ha.

10. The method according to claim 2, wherein the plant is selected from beets, corn, durum wheat, rapeseed, carrots, potatoes, solanaceae, cucurbits, lettuce or vine.

11. The method according to claim 2, not comprising the supply to said soil of an acid other than the acids naturally present in the red alga used to prepare the red alga extract, preferably the method does not comprise the supply to said soil of a carboxylic acid, for example a carboxylic acid selected from formic acid, acetic acid, lactic acid, citric acid, oxalic acid, propionic acid, malic acid, tartaric acid, fumaric acid, gluconic acid, sorbic acid and butyric acid.

12. The method according to claim 2, wherein the red alga extract is devoid of acid other than the acids naturally present in the red alga used to prepare the red alga extract.

13. The method according to claim 2, wherein the red alga extract is devoid of carboxylic acid.

14. The method according to claim 2, wherein the red alga extract is devoid of carboxylic acid selected from formic acid, acetic acid, lactic acid, citric acid, oxalic acid, propionic acid, malic acid, tartaric acid, fumaric acid, gluconic acid, sorbic acid and butyric acid.

15. The method according to claim 2, wherein the red alga extract is devoid of formic acid.

16. A nematostatic and/or nematicide composition comprising a red alga extract.

17. The nematostatic and/or nematicide composition according to claim 16, wherein the red alga is selected from Porphyra spp, Porphyra columbina, Porphyra acanthophora, Porphyra tenera, Porphyra perforata, Porphyra vietnamensis, Porphyra rosengurttii, Porphyra yezoensis, Porphyra haitanensis, even more preferably Porphyra spp or Porphyra columbina.

18. The nematostatic and/or nematicide composition according to claim 16, wherein the red alga extract is obtained by aqueous extraction at an acidic pH.

19. The nematostatic and/or nematicide composition according to claim 16, wherein the red alga extract is obtained by aqueous extraction at a pH comprised between 1 and 7, preferably between 2 and 6, even more preferably between 2 and 5.

20. The nematostatic and/or nematicide composition according to claim 16, wherein the red alga extract is obtained by aqueous extraction at a temperature comprised between 10 and 50° C., preferably between 20 and 50° C.

21. The nematostatic and/or nematicide composition according to claim 16, wherein the nematodes are pathogenic nematodes, preferably selected from the families Anguinidae, Longidoridae, Tylenchulidae, Pratylenchidae, Hoplolaimidae, Tylenchulidae, Trichodoridae, Heterodoridae, and Meloidogynidae.

22. The nematostatic and/or nematicide composition according to claim 16, wherein the red alga extract is devoid of acid other than the acids naturally present in the red alga used to prepare the red alga extract.

23. The nematostatic and/or nematicide composition according to claim 16, wherein the red alga extract is devoid of carboxylic acid.

24. The nematostatic and/or nematicide composition according to claim 16, wherein the red alga extract is devoid of carboxylic acid selected from formic acid, acetic acid, lactic acid, citric acid, oxalic acid, propionic acid, malic acid, tartaric acid, fumaric acid, gluconic acid, sorbic acid and butyric acid.
